(19) United States
(12) Patent Application Publication
(10) Pub. No.: US 2013/0266753 A1
(43) Pub. Date: Oct. 10, 2013

(54) RUBBER PAD CAPABLE OF REPEATED WASHING AND PEELING

(71) Applicant: Eng-Lun LIM, Taichung City (TW)

(72) Inventor: Eng-Lun LIM, Taichung City (TW)

(73) Assignee: Power Tac Enterprise, Ltd., Taichung City (TW)

(21) Appl. No.: 13/440,392

(22) Filed: Apr. 5, 2012

(51) Int. Cl. B32B 5/18; B32B 7/06; B32B 25/04; C09J 7/02; C09J 7/04

(52) U.S. Cl. 428/41.3; 428/41.8; 428/41.5

(57) ABSTRACT

A rubber pad capable of repeated washing and peeling includes a substrate, made of a sheet of certain thickness and area and defined into a first and a second side surface. An inertia adhesive layer is incorporated onto the first side surface to form an inertia bonding surface. The inertia bonding surface can be repeatedly peeled-off without residual colloid, and the temperature resistance range is between −20° C. and 120° C. An adhesion layer; incorporated onto the second side surface is made of glue of high adhesive capacity to form an adhesion surface. The adhesion surface is adhered securely at one time without repeated peeling-off. At least a debonding layer is attached onto at least the adhesion surface or inertia bonding surface in a peeling-off state.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an adhesive gasketing product, and more particularly to an innovative one which is designed into a rubber pad capable of repeated washing and peeling.

2. Description of Related Art Including Information Disclosed Under 37 CFR 1.97 and 37 CFR 1.98.

The adhesive gasketing products are widely applied to many articles in the people's everyday life for the purpose of gluing, resistance to falling and skidding, shakeproofing and anti-counterfeiting, etc.

In view of the shortcomings of traditional gluing products such as difficulty in cleaning up the residue, an adhesive pad capable of repeated peeling without residue has been developed into a variety of models with continuous R&D and competitive improvements. However, some problems and shortcomings are still observed in the actual applications.

Hereunder are some examples associated with the prior arts, such as: ROC patent No.: M302979: “a pad structure with adhesion effect”, which discloses a self-adhesive pad structure without degumming and colloid residue after peeling off; according to the characteristics of “thermoplastic rubber” and “recyclable residual wastes” defined in the prior art, despite of the difference of adhesive strength between the first and second sheets of said pad, this pad structure is made of TPR so as to generate the effects for repeated peeling off without residue. Yet, the following shortcomings are observed during actual applications:

Insufficient adhesive capacity: given that the sheets of the prior art are made of TPR, these two sheets of different adhesion degrees can be peeled off under weak adhesion states. When such structure is used for double-side glue, the glued objects must withstand the load (e.g.: hook), but the load cannot conform to the requirements due to poorer adhesive capacity.

Poorer temperature resistance: given that the TPR structure of the prior art is not resistant to high temperature, e.g.: softening, deformation and air bubbling may occur in an environment over 40° C., such structure used as a placing pad in the vehicles will cause high temperature in the parked vehicles and deformation of the placing pad; once upon deformation of the placing pad, oil stain will be overspilled from the colloid, leading to unsatisfactory visual effect and affecting greatly the orderly arrangement and stability of objects.

Lower dustproofing and difficulty in cleaning: given that hair and cotton chips (especially fine dust), etc, are adhered easily onto the surface of the TPR structure of the prior art, the porous structure containing oil substance makes it difficult for washing; and after several times of washing, the surface adhesive force will be weakened, thus affecting the durability and service life of the product.

Weak anti-skidding and absorbing capacity: given that the TPR structure of the prior art contains oil substance, oil stain will be overspilled or leaked from the colloid after a period of placement or solar radiation, leading to inability of withstanding load and resisting skidding.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

Based upon the unique construction of the present invention wherein “the improved rubber pad capable of repeated washing & peeling” mainly comprises a substrate, inertia adhesive layer, adhesion layer and debonding layer, the present invention allows to, via the technical characteristics of the inertia adhesive layer, use it extensively with repeated peeling-off but without mixing foreign matters and affecting its adhesive capacity after repeated cleaning. Moreover, its temperature resistance range can be expanded greatly, so it can be used in high-/low-temperature operating environments to meet high-load service conditions without deformation. To sum up, the present invention could enhance substantially the dust-proofing, heat resistance and moisture-proofing effects, improve anti-skidding, absorbing capacity and adhesive capacity, so as to augment its durability and extend the service life in a broader range of applications.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the present invention.

FIG. 2 is a plane sectional view of the present invention.

FIG. 3 is a plane sectional view of the present invention wherein a combined thickening layer is incorporated between the substrate and the adhesion layer.

FIG. 4 is a schematic view of the present invention wherein the rubber pad is of a single-sheet pattern.

FIG. 5 is a schematic view of the present invention wherein the rubber pad is of a multiple-overlapping pattern.

FIG. 6 is a schematic view of the present invention wherein the rubber pad is of a single-sheet curling pattern.

FIG. 7 is a partially enlarged sectional view of the present invention wherein the rubber pad is of a single-sheet curling pattern.

FIG. 8 is a schematic view of the present invention wherein the rubber pad is applied to the hooks.

FIG. 9 is a schematic view of the present invention wherein the inertia bonding surface of the inertia adhesive layer is a rough surface.

FIG. 10 is a plane sectional view of the present invention wherein the inertia bonding surface of the inertia adhesive layer is a rough surface.

FIG. 11 is a schematic view of the present invention wherein the rubber pad is used to carry loads.

FIG. 12 is a schematic view wherein the present invention is used on an oblique surface to prevent skidding of objects on the oblique surface.

### DETAILED DESCRIPTION OF THE INVENTION

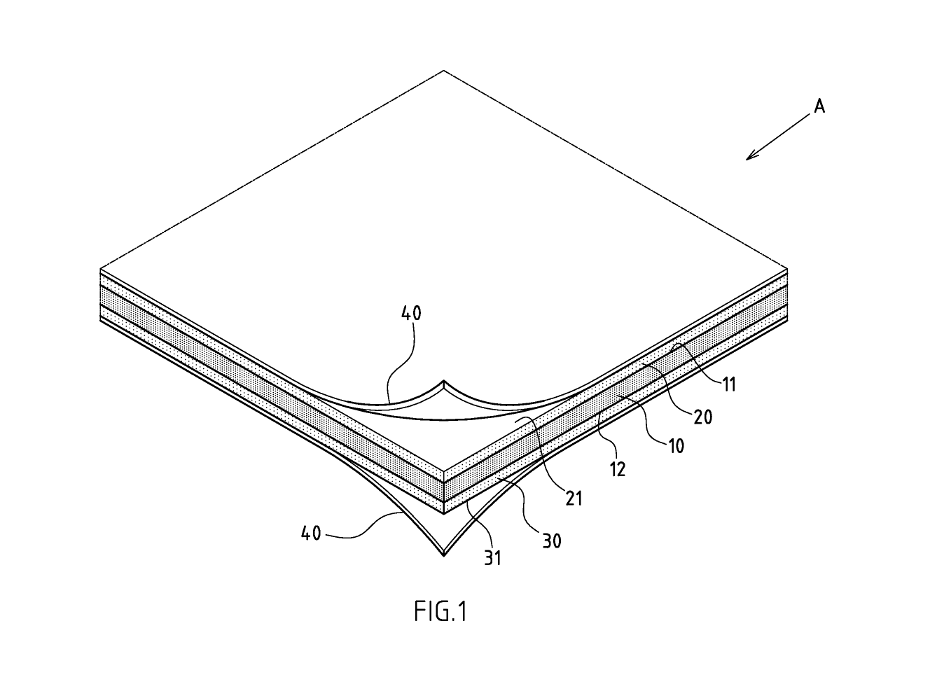

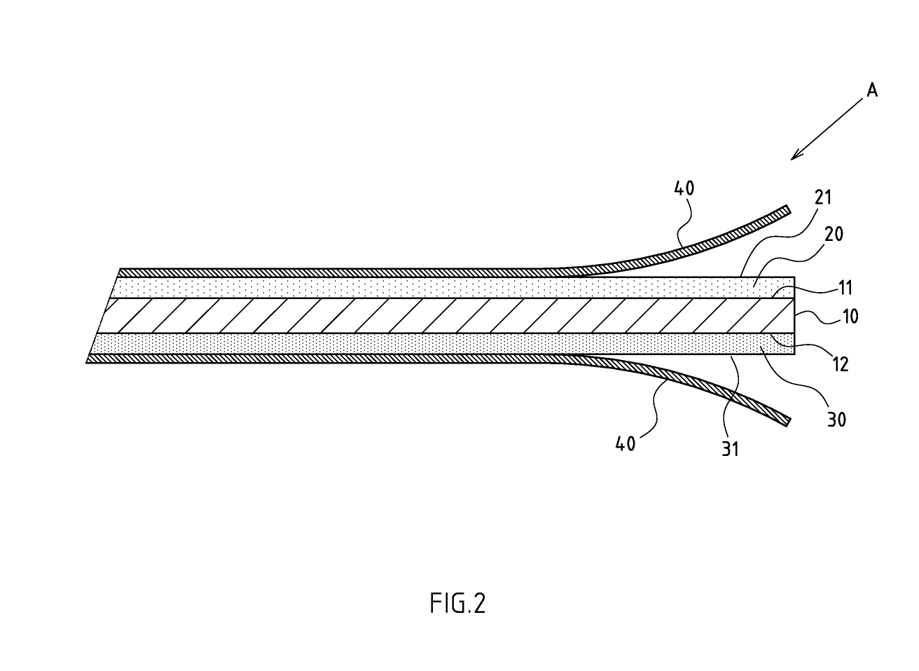

FIGS. 1-3 depict preferred embodiments of an improved rubber pad of the present invention capable of repeated washing and peeling, which, however, are provided for only explanatory objective for patent claims.

Said rubber pad A comprises a substrate 10, made of a sheet of certain thickness and area and defined into a first side surface 11 and a second side surface 12. The substrate 10 of the rubber pad A is made of either of TPU, PET, PE, PVC, PEVA, PP, PU, rubber film or cloth.

An inertia adhesive layer 20 is incorporated onto the first side surface 11 of the substrate 10, made of TPU or PU to form an inertia bonding surface 21. The inertia bonding surface 21 can be repeatedly peeled-off without residual colloid, and the temperature resistance range is between −20° C. and 120° C. Of which, if the inertia adhesive layer 20 is made of TPU or PU, making it more satisfactorily resisting to high temperature, abrasion and deformation and also preventing the pollution from foreign matters and dust as compared with TPR material. So, its adhesive capacity is not affected after repeated washing. Of which, TPU or PU material is categorized into injection, extrusion and film blowing grades, the higher grade means stronger resistance to temperature and abrasion.

An adhesion layer 30 is incorporated onto the second side surface 12 of the substrate 10, made of glue of high adhesive capacity to form an adhesion surface 31. The adhesion surface 31 is adhered securely at one time without repeated peeling-off. Of which the adhesion layer 30 of the rubber pad A is preferably made of PSA adhesion agent. Of which, the adhesion layer 30 and inertia adhesive layer 20 are separately set at both sides of the rubber pad A, enabling the users to select the adhesion surface 31 of the adhesion layer 30 if it is intended for permanent adhesion; or select the inertia bonding surface 21 of the inertia adhesive layer 20 for repeated peeling-off so as to meet the changing user demands.

At least a debonding layer 40 is attached onto at least the adhesion surface 31 or inertia bonding surface 21 in a peeling-off state.

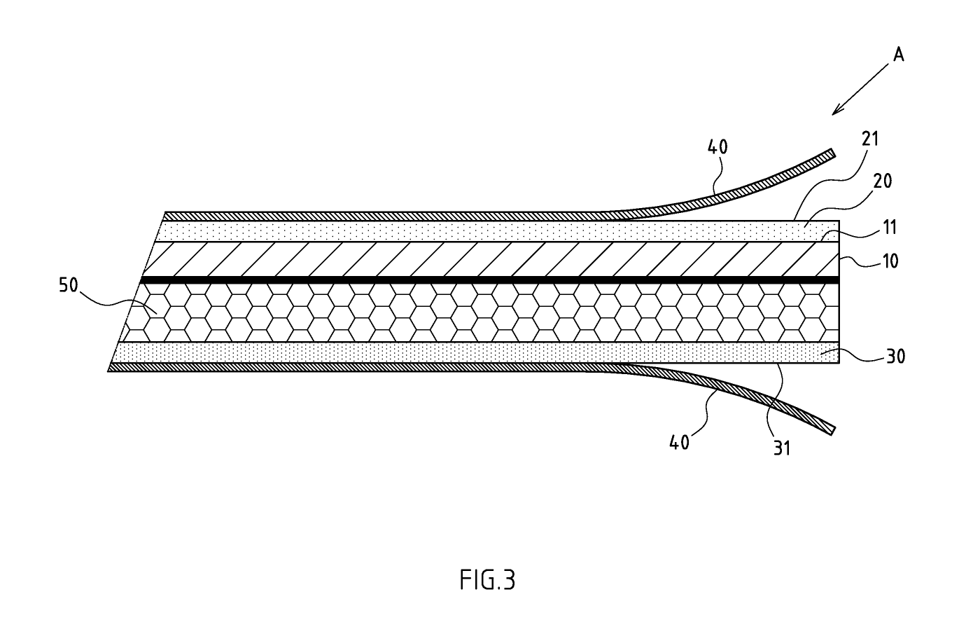

Referring to FIG. 3, a combined thickening layer 50 is incorporated between the substrate 10 and the adhesion layer 30. The combined thickening layer 50 is made of EVA foam, foam, PE foam, PE film, PU foam, PU film, PVC foam, PVC film, PP film PP foam, rubber film or cloth. If the substrate 10 is made of expensive TPU material, the combined thickening layer 50 can be made of aforementioned materials to reduce the cost and increase the thickness, so that the rubber pad A can be easily adhered with a certain pressing space. Moreover, the combined thickening layer 50 and the substrate 10 are incorporated by acryl glue or hot melt glue.

Referring to FIG. 4, said rubber pad A is of a single-sheet pattern. In such case, a debonding layer 40 is attached onto both the adhesion surface 31 and inertia bonding surface 21, so as to protect them against adhesion of any foreign matters.

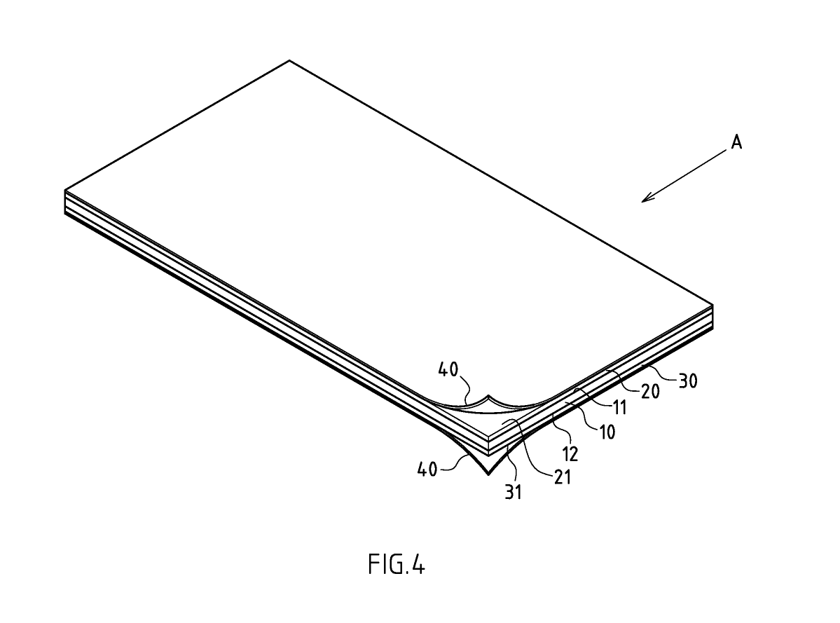

Referring also to FIG. 5, said rubber pad A is of a multiple-overlapping pattern. In such case, the debonding layer 40 can be incorporated between the adhesion surface 31 and inertia bonding surface 21 overlapped correspondingly.

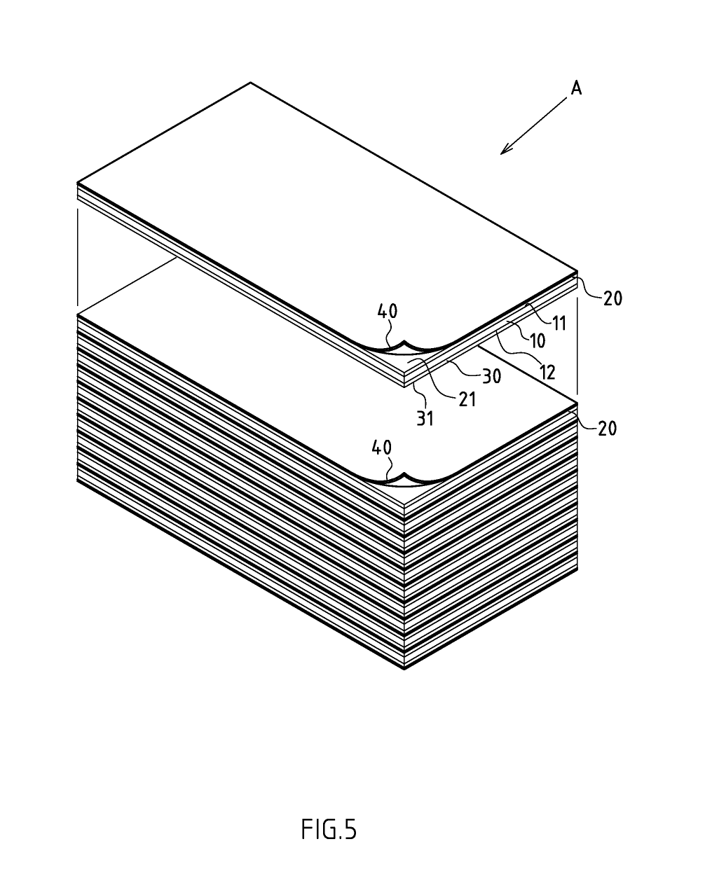

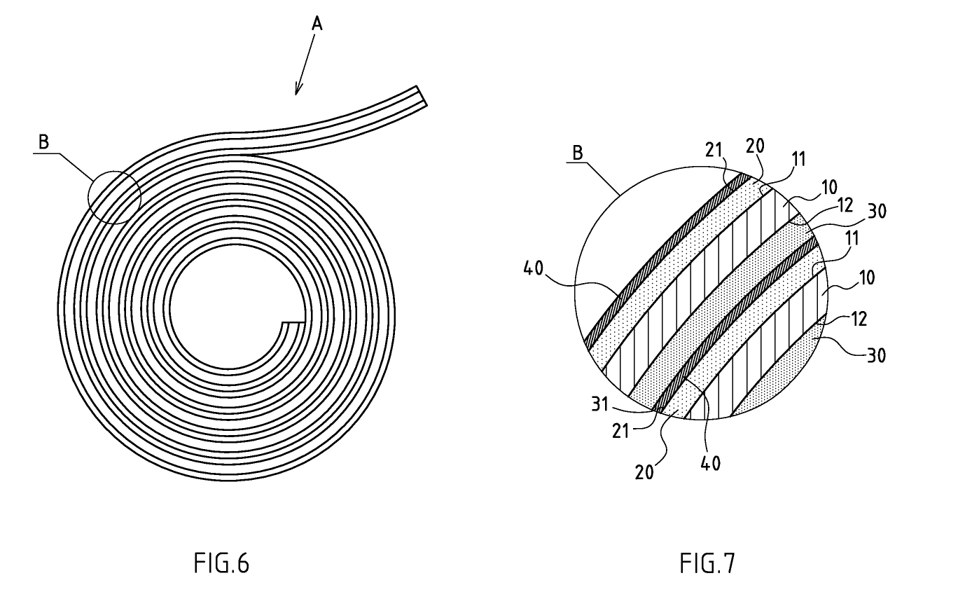

Referring to FIG. 6, said rubber pad A is of a single-sheet curling pattern. In such case, the debonding layer 40 can be incorporated between the adhesion surface 31 and inertia bonding surface 21 (shown in FIG. 7) overlapped correspondingly. The debonding layer 40 is made of high-density elastic plastics, helping to avoid any infiltration of dust from the spacing caused by folding lines. Moreover, the stripping characteristics of the debonding layer 40 correspond to repeated peeling-off characteristics of the adhesion layer 30 (rather than to the inertia adhesive layer 20 given the repeated peeling-off characteristics of TPU or PU inertia adhesive layer 20).

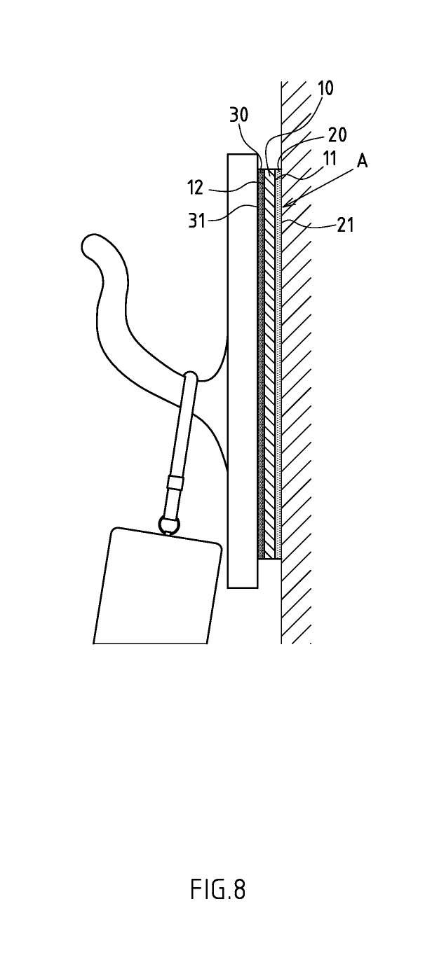

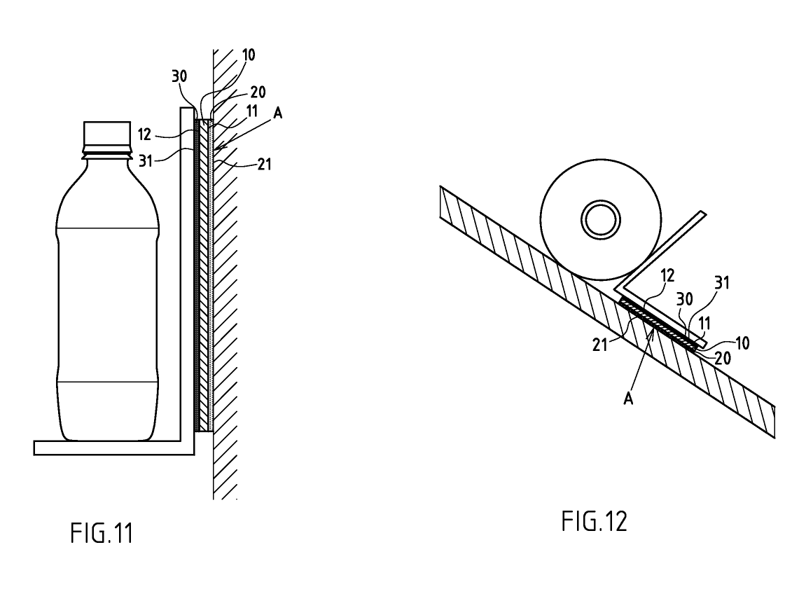

FIG. 8 depicts an application view of the present invention that the rubber pad A is applied to the hook, wherein it is adhered to one side of the hook via the adhesion layer 30. The inertia bonding surface 21 of the inertia adhesive layer 20 is a smooth surface (acryl or glass surface), onto which the inertia bonding surface 21 is adhered to enhance the absorbing capacity in response to high-load service state. FIG. 11 depicts an application view of the present invention that the rubber pad A is used to carry loads.

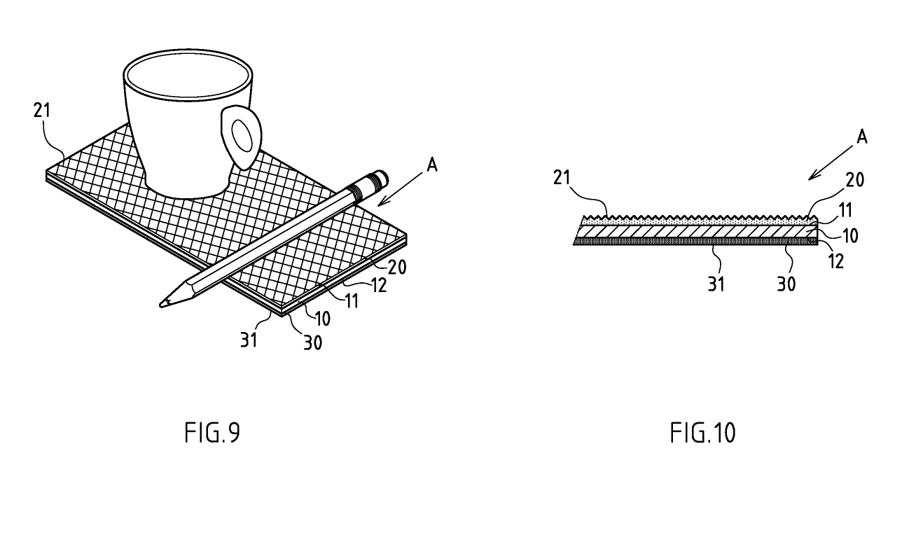

Referring to FIGS. 9 and 10, the inertia bonding surface 21 of the inertia adhesive layer 20 is a rough surface. When the rubber pad A allows to adhere onto a fixed surface (table) by the adhesion layer 30, it is possible to prevent skidding of the objects placed on the inertia bonding surface 21 of the inertia adhesive layer 20.

FIG. 12 depicts an application view that the present invention is used on an oblique surface to prevent skidding of objects placed on the oblique surface.

1. An improved rubber pad capable of repeated washing and peeling, of which said rubber pad comprising:
a substrate, made of a sheet of certain thickness and area and defined into a first and a second side surface;
an inertia adhesive layer, incorporated onto the first side surface of the substrate to form an inertia bonding surface; the inertia bonding surface can be repeatedly peeled-off without residual colloid, and the temperature resistance range is between −20° C. and 120° C.;
an adhesion layer, incorporated onto the second side surface of the substrate, and made of glue of high adhesive capacity to form an adhesion surface; the adhesion surface is adhered securely at one time without repeated peeling-off;
at least a debonding layer, attached onto at least the adhesion surface or inertia bonding surface in a peeling-off state.

2. The structure defined in claim 1, wherein the substrate of the rubber pad is made of either of TPU, PET, PE, PVC, PEVA, PP, PU, rubber film or cloth.

3. The structure defined in claim 1, wherein the adhesion layer of the rubber pad is preferably made of PSA adhesion agent.

4. The structure defined in claim 1, wherein said rubber pad is of a single-sheet pattern; in such case, a debonding layer is attached onto both the adhesion surface and inertia bonding surface.

5. The structure defined in claim 1, wherein said rubber pad is of a multiple-overlapping pattern; in such case, the debonding layer can be incorporated between the adhesion surface and inertia bonding surface overlapped correspondingly.

6. The structure defined in claim 1, wherein said rubber pad is of a single-sheet curling pattern; in such case, the debonding layer can be incorporated between the adhesion surface and inertia bonding surface overlapped correspondingly; and the debonding layer is made of high-density elastic plastics.

7. The structure defined in claim 1, wherein the inertia bonding surface of the inertia adhesive layer is a smooth surface.

8. The structure defined in claim 1, wherein the inertia bonding surface of the inertia adhesive layer is a rough surface.

9. The structure defined in claim 1, wherein a combined thickening layer is incorporated between the substrate and the adhesion layer; the combined thickening layer is made of EVA foam, foam, PE foam, PE film, PU foam, PU film, PVC foam, PVC film, PP film PP foam, rubber film or cloth.

10. The structure defined in claim 9, wherein the combined thickening layer and the substrate are incorporated by acryl glue or hot melt glue.

11. The structure defined in claim 1, wherein said inertia adhesive layer is made of TPU or PU materials.
